(19) United States
(12) Patent Application Publication
(10) Pub. No.: US 2025/0036876 A1
(43) Pub. Date: Jan. 30, 2025

(54) METHODS AND APPARATUS TO EVICT TOKENS FROM A KEY VALUE CACHE

(71) Applicant: Intel Corporation, Santa Clara, CA (US)

(72) Inventors: Alexander Kozlov, Dubai (AE); Liubov Talamanova, Dun Laoghaire (IE); Yury Gorbachev, Dubai (AE)

(73) Assignee: Intel Corporation, Santa Clara, CA (US)

(21) Appl. No.: 18/913,538

(22) Filed: Oct. 11, 2024

(51) Int. Cl. G06F 40/284; G06F 12/126

(52) U.S. Cl. CPC G06F 40/284; G06F 12/126

(57) ABSTRACT

Systems, apparatus, articles of manufacture, and methods are disclosed to evict tokens from a key value cache. An example apparatus includes interface circuitry, machine readable instructions, and programmable circuitry to at least one of instantiate or execute the machine readable instructions to: determine score history values for tokens based on attention scores associated with the tokens, wherein a token is a numerical representation of text, after a number of tokens present in the key value cache exceeds a threshold number of tokens, compute group importance scores for groups of tokens based on score history values of the tokens in the groups of tokens, identify low-ranked groups of tokens having lowest group importance scores, the low-ranked groups of tokens associated with an eviction range in the key value cache, and remove an identified low-ranked group of tokens from the eviction range of the key value cache.

### FIELD OF THE DISCLOSURE

This disclosure relates generally to key value caches and, more particularly, to methods and apparatus to evict tokens from a key value cache.

### BACKGROUND

Large language models (LLMs) are types of artificial intelligence programs that can analyze and understand text by using machine learning to generate and predict language. LLMs include an autoregressive Transformer model, which generates words, referred to as “tokens”, one at a time based on an input, referred to as a “prompt”, and a previous sequence of output tokens that the Transformer has generated so far. For example, a prompt input to an LLM of “what color is the sky?” results in a general purpose processor (e.g., CPU) tokenizing the prompt into a token tensor and transferring the token tensor to the Transformer to generate a response token, one word at a time (e.g., “the”, “sky”, “is”, “blue”).

### BRIEF DESCRIPTION OF THE DRAWINGS

FIG. 1 is a block diagram of example model execution circuitry in which example token eviction circuitry operates to evict tokens from an example key value cache to improve performance of the example model execution circuitry.

FIG. 2 is a block diagram of an example implementation of the token eviction circuitry of FIG. 1.

FIG. 3 is an illustration of the example key value cache of FIG. 1.

FIG. 4 is a flowchart representative of example machine readable instructions and/or example operations that may be executed, instantiated, and/or performed by example programmable circuitry to implement the model execution circuitry of FIG. 1.

FIG. 5 is a flowchart representative of example machine readable instructions and/or example operations that may be executed, instantiated, and/or performed by example programmable circuitry to implement the token eviction circuitry of FIGS. 1 and 2.

FIG. 6 is a block diagram of an example processing platform including programmable circuitry structured to execute, instantiate, and/or perform the example machine readable instructions and/or perform the example operations of FIGS. 4 and 5 to implement the token eviction circuitry of FIGS. 1 and 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Large language models (LLMs) have enabled new and useful applications such as programming assistants and universal chat bots. However, an inference workload (e.g., live data processing) of an LLM is an expensive workload for any type of hardware. Two reasons as to why inference of an LLM is expensive is (1) the size of the weights in the model and (2) the necessity to store key-value pairs associated with previously computed tokens in a key value cache. A key-value pair is a data structure (e.g., vectors) that consists of two related data elements: a key that defines a data set and a value belonging to that data set. The keys and values are vectors that correspond to an internal representation of a token. The necessity to store the key-value pairs comes from the inference process of autoregressive models mentioned above, where the model predicts text token (word) by token (word). This sequential generation process can be slow because the model can only generate one token at a time, and each new prediction is dependent on the previous context. For example, to predict token number 1000 in the sequence, the autoregressive model needs information from the previous 999 tokens, which comes in the form of matrix multiplications across the representations of those tokens. But to predict token number 1001, the model also needs the same information from the first 999 tokens, plus additional information from token number 1000. The key-value cache is used to optimize the sequential generation process by storing previous calculations to reuse in subsequent tokens, so that the previous tokens do not need to be computed again.

For large language models (LLMs), high throughput requirements mean batching many requests at a time. However, existing systems struggle because the key-value cache (KV cache) memory for each request is huge. Additionally, the KV cache grows and shrinks dynamically (e.g., based on the size of or number of requests). The size of a KV cache presents a problem for two reasons. The first reason is the amount of memory that is required to store the history tokens. The second reason is the number of service tasks that are required to allocate and efficiently populate the KV cache storage during the processing of a request. For example, a known generative text model with seven billion parameters that receives an input of 1024 tokens requires 512 MB of continuous storage along with a possibility of dynamic expansion (e.g., memory size adjusted as needed) during request processing. When managed inefficiently, this memory can be significantly wasted by fragmentation and redundant duplication and, thus, limits the batch size.

Some solutions to the above-mentioned cache management have been proposed. One solution is an algorithm that divides the request's KV cache into blocks, also referred to as pages, each of which can contain the attention keys and values of tokens. The pages are groups of tokens of a fixed size (e.g., 16 tokens per group). In the algorithm, the pages for the KV cache are not necessarily stored in contiguous space. Therefore, the KV cache is managed in a more flexible way. Such an approach allows allocating and freeing of memory efficiently during the cycles of text generation.

Another solution to the problem of KV cache and increasing amounts of requests is based on the idea of evicting parts (e.g., key-value pairs, tokens, etc.) of KV cache during the cycles of text generation. This eviction can be based on different importance criteria, such as an importance of key-pair values and tokens stored in the KV cache relative to the subsequent text to be processed. For example, a first eviction method is based on observations that the first tokens in the KV cache usually have the highest attention score in the self-attention operation layer. The self-attention operation layer is a layer in the model that turns an input x into a vector z via three representational vectors of the input: queries (q), keys (k), and values (v). These three representational vectors are used to calculate an attention score in the form of a matrix that shows how much attention that particular input should pay to other elements in the given input sequence. Due to the observations that the first tokens typically have the highest attention scores, this first method recommends freezing (e.g., keeping, not evicting, etc.) first tokens for the whole text generation process, while handling the rest of the KV cache in a first-in, first-out (FIFO) operation. FIFO would ensure that the oldest tokens are evicted first. Although this method performs well on the causal text generation tasks and chat based tasks, such as LLM tasks that respond to a question, the method does not work for tasks such as text summarization or retrieval augmented generation. In text summarization and/or retrieval augmented generation, the most important tokens are located in the middle of a KV cache and need to be kept, rather than evicted, through the entire text generation process.

A second eviction method exploits the additional information that is available during model inference. For example, the second eviction method uses an attention score matrix to estimate an importance of each token in the KV cache. The second eviction method creates the attention score matrix by summing a history of attention scores for each token. Then, the second eviction method keeps the tokens with the largest sum in the KV cache and evicts the rest. Similar to the first eviction method, the second eviction method also excludes a subset of the most recent tokens from the eviction process to make the result more robust. The reason for keeping (e.g., freezing) the most recent tokens is that the generated text depends on the recent tokens that should be kept to make the text smooth. However, while this second eviction method performs well on the text summarization tasks, due to giving favor to the tokens that attended most through the history of generation cycles, the method cannot correctly handle scenarios that the first eviction method can (e.g., causal text generation tasks and chat based tasks). This method cannot handle those types of tasks because the importance of the tokens in the KV cache can vary and highly depends on the current user's prompt (preference).

Lastly, both methods also do not operate with the first mentioned approach of storing the KV cache in blocks of memory (pages), where the pages that are groups of tokens of a fixed size (e.g. 16 tokens per group). As described above, this approach allows allocating and freeing of memory efficiently during the cycles of text generation. Applying the aforementioned token eviction methods along with the pages approach would cause inefficient memory utilization or additional overhead, where the additional overhead comes from a need to rearrange tokens within pages to reduce blanks caused by evicted tokens.

Examples disclosed herein provide methods and apparatus to improve the problem in KV cache caused by large input data into an LLM performing any type of inference (e.g., causal text generation tasks, chat based tasks, text summarization tasks, retrieval augmented generation tasks). Examples disclosed herein provide a token eviction method that is applicable to the page approach. Examples disclosed herein efficiently limit a size of memory required to store the KV cache of text generation models without compromising accuracy. Examples disclosed herein do this by splitting the KV cache into three parts: (1) start tokens, (2) evicting tokens, and (3) recent tokens. Examples disclosed herein apply different eviction strategies to parts of the KV cache and handles tokens in a group-wise manner in order to comply with the page approach.

Examples disclosed herein reduce an amount of memory for KV cache storage that is required for LLM request processing. Examples disclosed herein outperform the aforementioned existing solutions in terms of accuracy and scalability to target tasks. Examples disclosed herein improve efficiency of inference workloads of text generation models and enables deployment of text generation models on accelerators (e.g., neural processing unit (NPU), integrated graphics processing unit (iGPU), discrete graphics processing unit (dGPU), etc.) that have a more limited amount of storage (e.g., memory, RAM) available for the AI model inference.

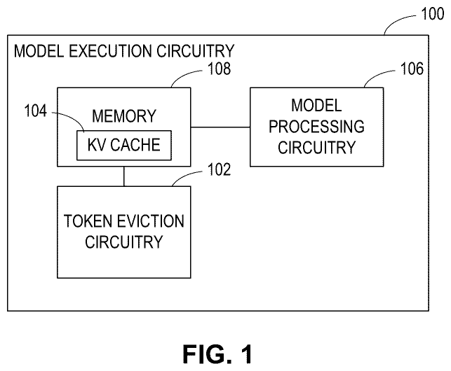

FIG. 1 is a block diagram of example model execution circuitry 100 in which example token eviction circuitry 102 operates to evict tokens from an example KV cache 104 to improve performance of the model execution circuitry 100. The model execution circuitry 100 includes example model processing circuitry 106 and an example memory 108.

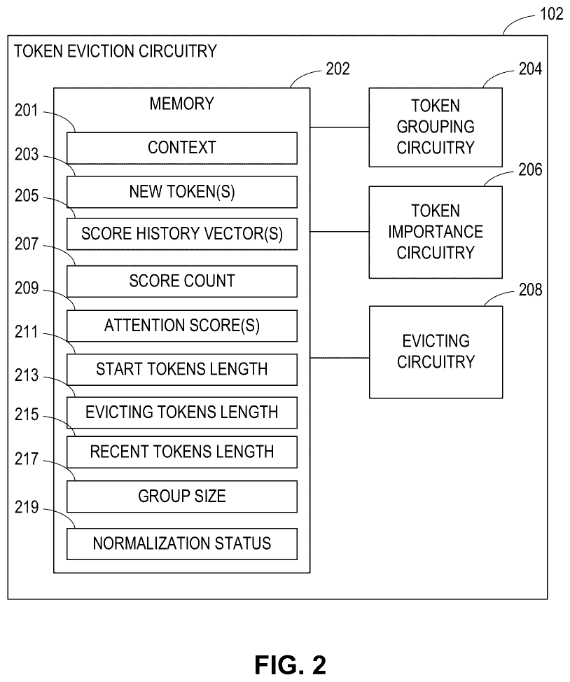

In FIG. 1, the token eviction circuitry 102 controls the KV cache 104. The token eviction circuitry 102 consists of three components. The first component includes dividing the KV cache 104 into three different parts upon receipt of an input and during text generation. For example, when the model execution circuitry 100 receives an input, such as a question, a request to summarize text, etc., the token eviction circuitry 102 creates a first part of the KV cache called start tokens. As the model execution circuitry 100 and/or the model processing circuitry 106 processes the input request, the token eviction circuitry 102 creates the second and third parts of the KV cache, called evicting tokens and recent tokens. The second component of the token eviction circuitry 102 includes grouping tokens into pages (e.g., blocks of memory). The third component of the token eviction circuitry 102 includes calculating an importance score for each group of tokens and evicting the tokens based on the importance score. For example, the token eviction circuitry 102 can evict a group of tokens having a lowest importance score relative to other groups of tokens. The example token eviction circuitry 102 is described in further detail below in connection with FIG. 2.

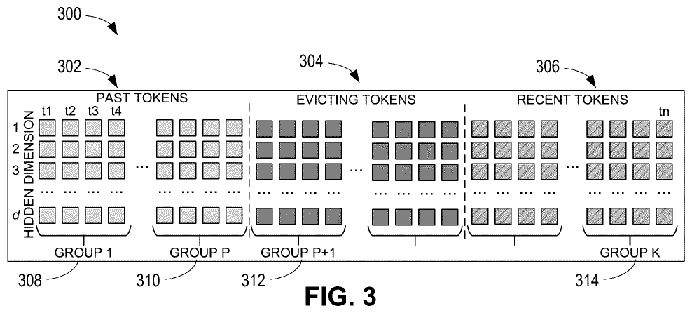

In FIG. 1, the KV cache 104 is cache located within the memory 108 and configured to store a subset of data, typically transient in nature, so that future requests for that data are served up faster than is possible by accessing the data's primary storage location (e.g., the memory 108). For example, the KV cache 104 stores keys and values of tokens that can be quickly accessed by the model processing circuitry 106 while performing the sequential text generation process. Basically, the KV cache 104 is used to store the context (e.g., key-value pairs) from earlier tokens, which is necessary for the model processing circuitry 106 to generate new output tokens in a sequence. The KV cache 104 holds the information that the model processing circuitry 106 uses to understand the sequence it has processed so far and to predict the next token. An illustration of the pages of the KV cache 104 is shown in FIG. 3 and described in further detail below.

In FIG. 1, the model processing circuitry 106 is hardware configured to execute layers of a machine learning model, such as a text generation machine learning model, to perform tasks requested by the input. For example, the model processing circuitry 106 may be implemented by a graphics processing unit (GPU), a neural processing unit (NPU), a central processing unit (CPU), a Field Programmable Gate Array (FPGA), or any type of acceleration or specialized hardware capable of performing text generation tasks. In this example, the model processing circuitry 106 is configured to process an LLM, which generates tokens one at a time based on a prompt and a previous sequence of the output's tokens that the LLM has generated so far.

In some examples, the LLM uses an attention mechanism which allows a model to focus on different parts of the input sequence when generating each element of the output sequence. The attention mechanism is a layer that uses a set of queries Q, keys K, and values V, which are all weight matrices that are produced by a previous layer in the model's stack of layers. The attention layer uses the Q, K, V, matrices to generate an attention score vector for an input token x. The attention score vector is a matrix of a particular dimension that shows how much attention input token x should pay to other elements in the given sequence. For example, the model processing circuitry 106 is to process a sentence with n words (e.g., the sequence length). Each word is represented by a dimensional vector d, where d is a hidden size of the model. For example, d represents a number of layers in of the model. The dimension of keys, queries, and values is d_k. In this example, the input matrix x has dimensions [n×d]. The matrices Q, K, and V are of dimensions [n×d_k]. The model processing circuitry 106 outputs an [n×n] attention score matrix representing attention scores for each word relative to every other word.

Lastly, the model processing circuitry 106 applies a softmax function to the attention score matrix to generate a weighted attention score matrix of dimension [n×d_k]. The softmax function is a function that turns a vector of K real values (e.g., [n×n] attention score matrix) into a vector of K real values (e.g., weighted attention score matrix of dimension [n×d_k]) that sum to one so that the real values can be interpreted as probabilities. For example, in a matrix of n=1 and d=6, there are 6 attention scores in the matrix all adding up to one, where a value closer to zero indicates a low attention score of the token and a value closer to one indicates a high attention score. For example, a weighted attention score matrix for an input token x of size n=1 and d=6 could be [0.05, 0.1, 0.05, 0.1, 0.1, 0.6].

In some examples, the LLM has more than one attention layer. For example, as an input token x is being processed by the model, multiple attention layers are extracting from and transforming the input token x into a concise and accurate output. Therefore, the model processing circuitry 106 may generate more than one attention score matrix for a single token. As such, each token may have an attention score history which includes all previous attention scores generated for the token.

In addition to generating attention scores for tokens, the model processing circuitry 106 accesses the KV cache 104 for previous sequences of tokens in order to predict the next token. In some examples, the model processing circuitry 106 provides the KV cache 104 with the previously generated tokens, attention scores corresponding to those tokens, and a running count of how many tokens have been generated.

In FIG. 1, the memory 108 stores data used by the model processing circuitry 106, including tokens, attention scores corresponding to those tokens, and a running count of how many tokens have been generated. The memory 108 of FIG. 1 is implemented by any memory, storage device and/or storage disc for storing data such as, for example, flash memory, magnetic media, optical media, solid state memory, hard drive(s), thumb drive(s), etc. Furthermore, the data stored in the memory 108 may be in any data format such as, for example, binary data, comma delimited data, tab delimited data, structured query language (SQL) structures, etc. While, in the illustrated example, the memory 108 is illustrated as a single memory, the memory 108 and/or any other data storage devices described herein may be implemented by any number and/or type(s) of memories.

FIG. 2 is a block diagram of an example implementation of the token eviction circuitry 102 of FIG. 1 to evict tokens from the KV cache 104 to improve performance of the model execution circuitry 100. The token eviction circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the token eviction circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

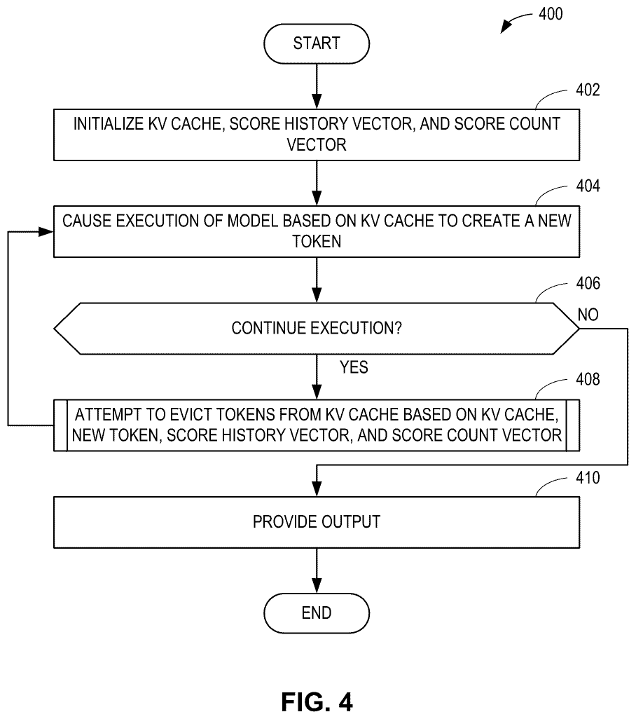

The token eviction circuitry 102 of FIG. 2 includes an example memory 202, example token grouping circuitry 204, example token importance circuitry 206, example evicting circuitry 208. In some examples, the token grouping circuitry 204 is instantiated by programmable circuitry executing token grouping circuitry instructions and/or configured to perform operations such as those represented by the flowchart(s) of FIG. 4. In some examples, the token importance circuitry 206 is instantiated by programmable circuitry executing token importance circuitry instructions and/or configured to perform operations such as those represented by the flowchart(s) of FIG. 4. In some examples, the eviction circuitry 208 is instantiated by programmable circuitry executing eviction circuitry instructions and/or configured to perform operations such as those represented by the flowchart(s) of FIG. 4.

In FIG. 2, the memory 202 stores data used by the token grouping circuitry 204, the token importance circuitry 206, and the eviction circuitry 208 to determine which tokens to evict from the KV cache 104 (FIG. 1). The memory 202 stores context data 201, new token(s) 203, score history vector(s) 205, score count vector 207, attention score(s) 209, start tokens length(s) 211, evicting tokens length 213, recent token length 215, group size data 217, and a normalization status 219.

The context data 201 is cached tokens with their corresponding keys and values output by the attention mechanism and processed by the model processing circuitry 106.

New token(s) 203 is/are the currently generated key and value tokens that fall in the context data 201 and computed by the model processing circuitry 106.

A score history vector 205 is a vector representative of aggregated sums of attention scores (e.g., aggregated importance scores) of a token. For example, each token may have more than one attention score matrix and, thus, more than one importance score.

A score count vector 207 is data representative of a number of the scores in the score history vector 205 and/or representative of a number of executed iterations of text generation performed by the model processing circuitry 106.

Attention score(s) 209 is/are the matrix output(s) of the attention layer of an LLM. For example, an attention score 209 of a first token may be a matrix having a number of values between zero and one, where the number of values is equal to the hidden size of the model.

A start tokens length 211 is an initial number of tokens at the beginning of the context data 201 to keep in the start tokens part of the KV cache 104. The start tokens length 211 is defined by a user and/or administrator. The start tokens length 211 defines an initial token threshold in the KV cache 104.

An evicting tokens length 213 is a number of the tokens that are to undergo the eviction process. The evicting tokens length 213 is defined by the user and/or administrator.

A recent tokens length 215 is a recent number of the tokens at the end of the context data 201 to keep. The recent tokens length 215 is determined defined by the user. The recent tokens length 215 defines a recent tokens threshold in the KV cache 104.

Group size data 217 is a size of the group of tokens in the context data 201. The group size data 217 determined by a user. The context data 201 is evenly separated into the groups, and the last group is filled with recently generated tokens (e.g., new token(s) 203).

A normalization status 219 is a status indicative of whether the token eviction circuitry 102 is to normalize the importance scores of the tokens or not to normalize the importance scores.

The memory 202 of FIG. 2 is implemented by any memory, storage device and/or storage disc for storing data such as, for example, flash memory, magnetic media, optical media, solid state memory, hard drive(s), thumb drive(s), etc. Furthermore, the data stored in the memory 202 may be in any data format such as, for example, binary data, comma delimited data, tab delimited data, structured query language (SQL) structures, etc. While, in the illustrated example, the memory 202 is illustrated as a single memory, the memory 202 and/or any other data storage devices described herein may be implemented by any number and/or type(s) of memories. The memory 202 may implement the means for storing context data 201, new token(s) 203, score history vector(s) 205, score count vector 207, attention score(s) 209, start tokens length(s) 211, evicting tokens length 213, recent token length 215, group size data 217, and normalization status 219.

In FIG. 2, the token grouping circuitry 204 groups tokens into a page and assigns the page to one of the three parts of the KV cache 104. As described below in connection with FIG. 3, the KV cache 104 is split into three different parts: start tokens, evicting tokens, and recent tokens. Each part represents a location in the KV cache 104: beginning, middle, and end. For example, if the KV cache 104 is implemented by contiguous memory, the start tokens part may be beginning or earlier addresses in the KV cache 104, the evicting tokens part may be middle addresses in the KV cache 104, and the recent tokens part may be last or later addresses in the KV cache 104. The size of each part (e.g., each set of addresses) of the KV cache 104 can vary depending on the model being executing by the model processing circuitry 106, the task, and any hardware limitations, such as memory size limitations. The token grouping circuitry 204 uses the context data 201, the new token(s) 203, and the group size data 217 to create the groups (e.g., the pages). For example, the group size data 217 may be eight (8), indicating that each page should include eight tokens. As tokens are generated, the token grouping circuitry 204 adds them to a page until the page is full (e.g., until the page has eight tokens). Based on the time the tokens in the page were generated, the token grouping circuitry 204 assigns the page to either the start token part of the KV cache 104, the evicting tokens part, or the recent tokens part.

For example, turning to FIG. 3, an example KV cache 300 is illustrated. The KV cache 300 may be the KV cache 104 of FIG. 1. The KV cache 300 is split into an example first portion 302, an example second portion 304, and an example third portion 306.

In FIG. 3, the first portion 302 is a section of the KV cache 300 reserved for the start tokens. As used herein, the start tokens are tokens corresponding to the prompt input and that fall within an initial token threshold. For example, if a user input a prompt such as “what color is the sky?”, then a token representative of “what”, a token representative of “color”, a token representative of “is”, a token representative of “the”, and a token representative of “sky” are assigned to the first portion 302 of the KV cache 300. In such an example, the sequence length n would be equal to five. These start tokens are located earlier in the KV cache 300 than an initial token threshold. As used herein, an initial token threshold is a number defined by the start tokens length 211 that defines a range of tokens that may fall within the first portion 302. For example, the range begins at zero (e.g., the first generated token) and stops at the initial token threshold (e.g., 10 tokens, 20 tokens, 30 tokens, etc.).

The first portion 302 includes an example first group 308 having a first token t1, a second token t2, a third token t3, and a fourth token t4. The tokens t1-t4 have a hidden dimension size d, where each token has d attention scores. The token grouping circuitry 204 of FIG. 2 groups the first token t1, second token t2, third token t3, and fourth token t4 into the first group 308 based on the time at which the tokens were generated by the model processing circuitry 106 of FIG. 1. For example, the first token t1 is generated before the second token t2, the second token t2 is a token generated after the first token t1 and before the third token t3, the third token t3 is a token generated after the second token t2 and before the fourth token t4, etc. The token grouping circuitry 204 assigns the first group 308 to the first portion 302 based on the first, second, third, and fourth tokens corresponding to the prompt input. In some examples, more than one group (e.g., page) can be assigned to the first portion 302. For example, the token grouping circuitry 204 assigns a second group 310 to the first portion 302 of the KV cache 300. The second group 310 may be a group of tokens corresponding to tokens generated after the prompt tokens were generated.

In FIG. 3, the second portion 304 of the KV cache 300 is section reserved for pages of tokens that can be evicted. Tokens that can be evicted are tokens that are not prompt tokens and are not recently generated tokens. Tokens that can be evicted are tokens that are in the middle of a sequence of tokens that were already used to generate the text in the past and are no longer important to the remaining text generation process. The second portion 304 includes an example third group 310 having a four tokens. The token grouping circuitry 204 of FIG. 2 groups the four tokens into the third group 312 based on the time at which the tokens were generated by the model processing circuitry 106 of FIG. 1. The token grouping circuitry 204 assigns the third group 312 to the second portion 304 based on a number of recently generated tokens. For example, when the model processing circuitry 106 has generated a certain number of tokens after the third group of tokens 312 were generated, the token grouping circuitry 204 moves and/or reassigns the third group 312 to the second portion 304 of the KV cache 300 as candidates that could be evicted.

In FIG. 3, the third portion 306 is a section of the KV cache 300 reserved for the most recently generated tokens. The tokens in the third portion 306 are treated as important to have for smooth text generation process. For example, the model processing circuitry 106 uses recently generated tokens, stored in the KV cache 300, to generate the next token. After a certain amount of text generation iterations, that group of most recently generated tokens becomes less important for subsequent text generation and, thus, can be reassigned to the second portion 304. In other words, the oldest tokens from the third portion 306 fall to (e.g., are reassigned to) the second portion 304 through the cycles of text generation and can undergo an eviction process. These recent tokens are located later in the KV cache 300 than a recent token threshold. As used herein, a recent token threshold is a number defined by the recent tokens length 215 that defines a range of tokens that may fall within the third portion 306. For example, the range begins at the recent tokens threshold zero (e.g., 60 tokens) and stops at the maximum tokens length for the KV cache 300 (e.g., 100 tokens, etc.).

In FIG. 3, the third portion 306 includes a fourth group 314. The fourth group 314 is a page of tokens that are most recently generated. In some examples, a certain amount of memory in the KV cache 300 is reserved for that most recently generated group of tokens, which is why one or more groups of tokens are to be evicted from the second portion 304 to make room for the most recently generated group of tokens.

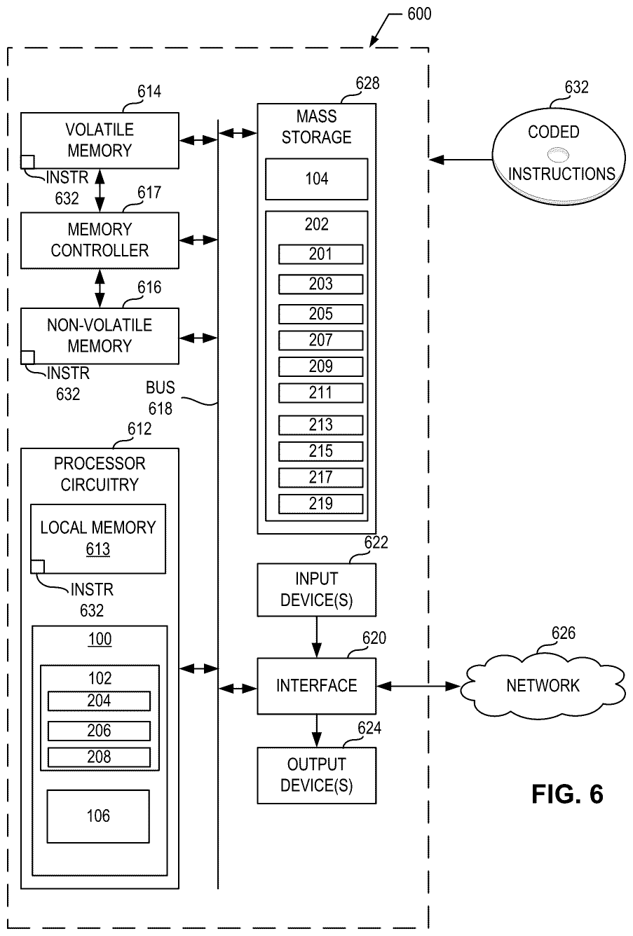

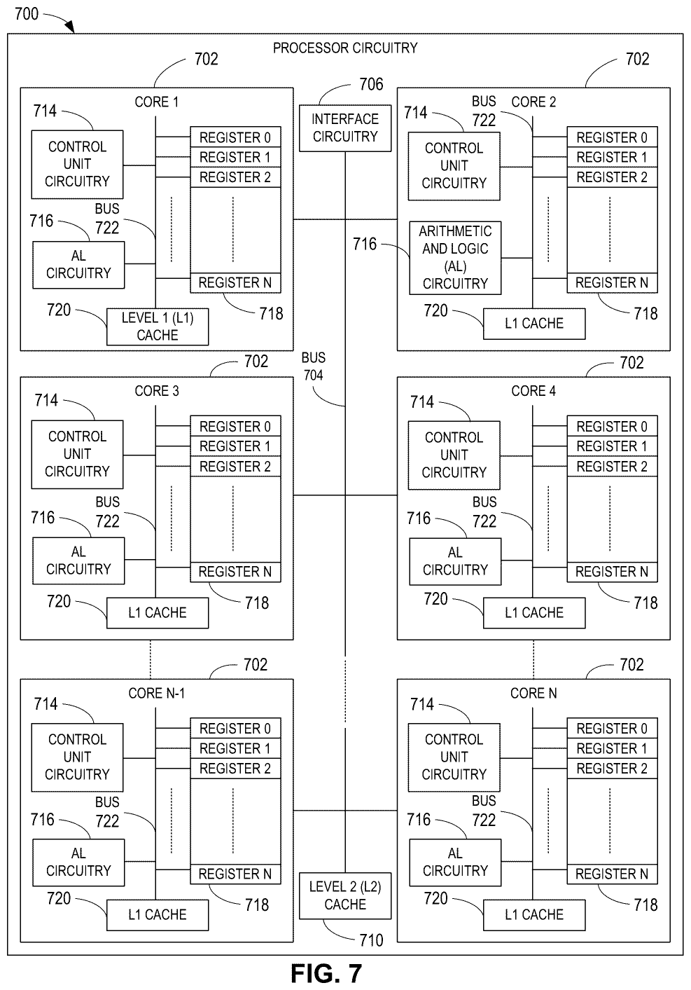

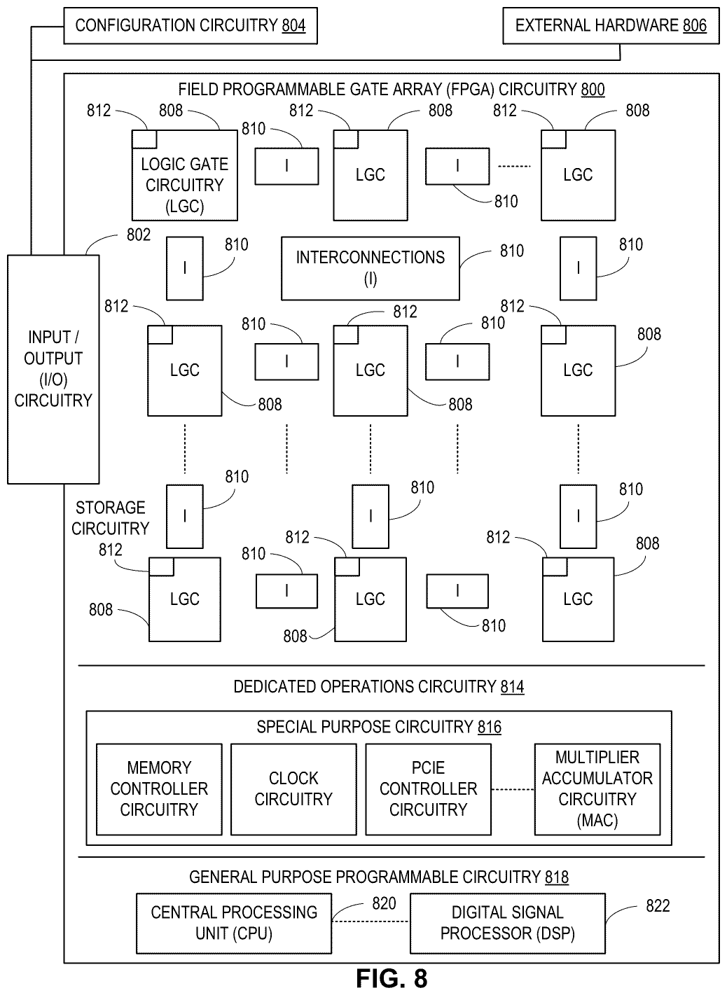

In some examples, the token grouping circuitry 204 includes means for grouping tokens. For example, the means for grouping tokens may be implemented by token grouping circuitry 204. In some examples, the token grouping circuitry 204 may be instantiated by programmable circuitry such as the example programmable circuitry 612 of FIG. 6. For instance, the token grouping circuitry 204 may be instantiated by the example microprocessor 700 of FIG. 7 executing machine executable instructions such as those implemented by at least block 402 of FIG. 4. In some examples, token grouping circuitry 204 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the token grouping circuitry 204 may be instantiated by any other combination of hardware, software, and/or firmware. For example, the token grouping circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for grouping tokens includes means for assigning groups of tokens to portions and/or parts of a KV cache.

Returning to FIG. 2, the token importance circuitry 206 determines an importance score per token and an importance score per group (e.g., page) of tokens in the KV cache 104. As used herein, an importance score is a numerical value indicative of an importance of the group of tokens to the remaining text generation process. The token importance circuitry 206 first determines an importance of each token individually before calculating the importance score of a group. To determine the current importance score of a token, the token importance circuitry 206 sums n attention score matrices 209 corresponding to the token. The token importance circuitry 206 then generates the score history vector 205 of the token by adding the current importance scores of the token to the attention scores 209 of the token. In examples disclosed herein, the importance score history vector 205 and importance score history value 205 are used interchangeably.

Prior to determining an importance score per group, the token importance circuitry 206 determines whether the score history value 205 is to be normalized based on the normalization status 219. When the normalization status 219 indicates that the score history vector 205 is to be normalized, score history value 205 is divided by the score count vector 207. In some examples, the token importance circuitry 206 updates the score count vector 207 prior to normalization, depending on whether a new token 203 has been received. When a new token 203 is received, the token importance circuitry 206 increments a number in the score count vector 207 by one, and then normalizes the score history value 205. The incremented score count vector 207 should be equivalent to a number of elements (e.g., attention scores) in the token. For example, the score count vector 207 is a number indicative of how many execution iterations or layers the token has been through and, therefore, how many scores are in the score history vectors 205.

In some examples, the normalization status 219 does not indicate that normalization is to occur and the token importance circuitry 206 does not normalize the importance score of each token. For example, normalization is optional and depends on the task and the type of model being executed by the model processing circuitry 106. When the normalization status 219 does not indicate that normalization is to occur, the token importance circuitry 206 initializes the score history vector 205 to be considered the “normalized importance score” for the token.

Finally, the token importance circuitry 206 uses the normalized importance score of each token in a group to determine the group importance score of the group of tokens. For example, the token importance circuitry 206 sums the normalized importance scores of the all the tokens in the selected group to obtain the group score.

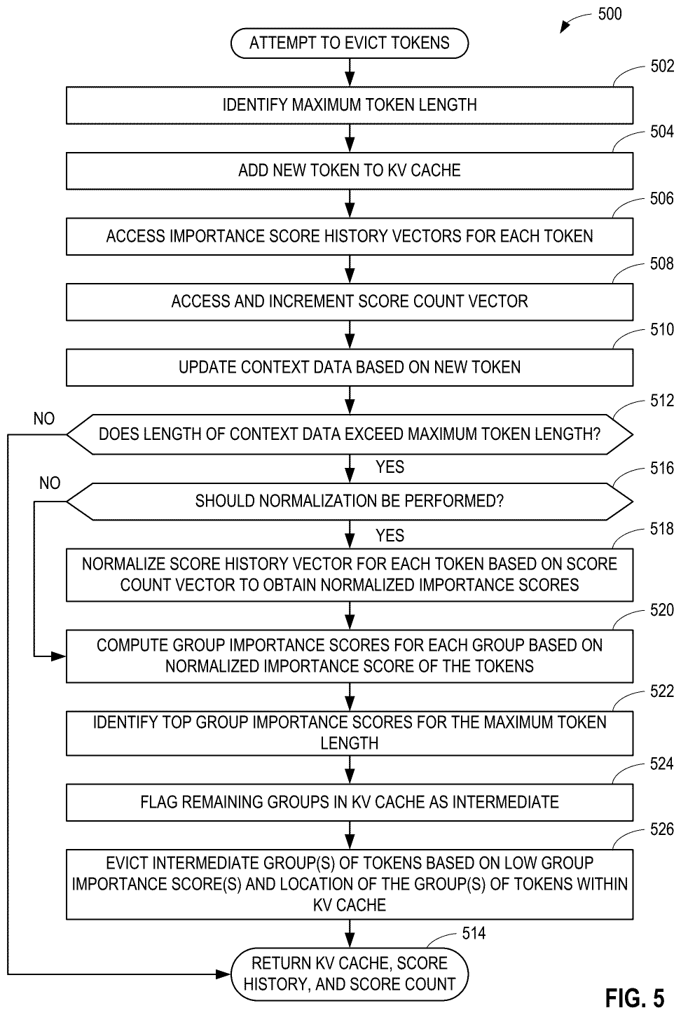

In some examples, the token importance circuitry 206 includes means for determining group importance score for each group of tokens. For example, the means for determining group importance scores for each group of tokens may be implemented by token importance circuitry 206. In some examples, the token importance circuitry 206 may be instantiated by programmable circuitry such as the example programmable circuitry 612 of FIG. 6. For instance, the token importance circuitry 206 may be instantiated by the example microprocessor 700 of FIG. 7 executing machine executable instructions such as those implemented by at least blocks 506, 508, 516, 518, and 520 of FIG. 5. In some examples, the token importance circuitry 206 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the token importance circuitry 206 may be instantiated by any other combination of hardware, software, and/or firmware. For example, the token importance circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for determining group importance scores includes means for determining importance score history vectors. In some examples, the means for determining group importance scores includes means for incrementing a score count vector. In some examples, the means for determining group importance scores includes means for normalizing the score history vectors. In some examples, the means for determining group importance scores includes means for summing attention scores to determine a current importance score.

In FIG. 2, the evicting circuitry 208 determines groups to evict from the KV cache 104. Prior to eviction, the evicting circuitry 208 determines the maximum token length of the KV cache 104. The maximum token length of the KV cache 104 is a threshold number of tokens that the KV cache 104 can store. The evicting circuitry 208 calculates the maximum token length based on adding the start tokens length 211 to the evicting tokens length 213 and the recent tokens length 215. In some examples, the threshold number of tokens is determined based on a size of the KV cache 104. For example, the threshold number of tokens is determined based on how many tokens the KV cache 104 can store.

Once the maximum token length is determined, the evicting circuitry 208 determines whether a length of the context data 201 is less than or equal to the maximum tokens length. As a reminder, the context data 201 is cached tokens with their corresponding keys and values and is always updated when a new token is generated. For example, the evicting circuitry 208 concatenates a new token to the context data 201 to update the context data 201. When the length of the context data 201 is less than or equal to the maximum token length, the evicting circuitry 208 stores the score history vector 205 and the score count vector 207 in the memory 202 along with the updated context data 201.

When the length of the context data 201 exceeds the maximum token length, the evicting circuitry 208 determines the top ranked groups in the KV cache 104. To determine the top ranked groups in the KV cache 104, the evicting circuitry determines the top group scores for the maximum token length. For example, if the maximum token length is equal to 100 and the group size is equal to five, the evicting circuitry 208 determines 20 groups with the highest group importance score and flags them as a top ranked group. The evicting circuitry 208 flags the remaining groups in the KV cache 104 as intermediate ranked group.

Lastly, to evict groups of tokens from the KV cache 104, the evicting circuitry 208 identifies the intermediate ranked groups with the lowest group importance scores that are located in the evicting part of the KV cache 104 and removes those groups from the KV cache 104. Any remaining intermediate ranked groups are kept in the start tokens part (e.g., initial token threshold) and/or the recent tokens part (e.g., recent token threshold) of the KV cache 104.

In some examples, the evicting circuitry 208 includes means for removing a group of tokens from the key value cache. For example, the means for removing a group of tokens from the key value cache may be implemented by the evicting circuitry 208. In some examples, the evicting circuitry 208 may be instantiated by programmable circuitry such as the example programmable circuitry 612 of FIG. 6. For instance, the evicting circuitry 208 may be instantiated by the example microprocessor 700 of FIG. 7 executing machine executable instructions such as those implemented by at least blocks 502, 512, 522, 524, 526, and 514 of FIG. 5. In some examples, the evicting circuitry 208 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the evicting circuitry 208 may be instantiated by any other combination of hardware, software, and/or firmware. For example, the evicting circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for removing a group of tokens from the key value cache includes means for identifying a maximum token length. In some examples, the means for removing a group of tokens from the key value cache includes means for updating a length of context data. In some examples, the means for removing a group of tokens from the key value cache includes means for determining whether the length of the context data exceeds the maximum token length. In some examples, the means for removing a group of tokens from the key value cache includes means for identifying top group importance scores for the maximum token length. In some examples, the means for removing a group of tokens from the key value cache includes means for flagging remaining groups in the key value cache as intermediate.

While an example manner of implementing the token eviction circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example memory 202, the example token grouping circuitry 204, the example token importance circuitry 206, the example evicting circuitry 208, and/or, more generally, the example token eviction circuitry 102 of FIG. 2, may be implemented by hardware alone or by hardware in combination with software and/or firmware. Thus, for example, any of the example memory 202, the example token grouping circuitry 204, the example token importance circuitry 206, the example evicting circuitry 208, and/or, more generally, the example token eviction circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example token eviction circuitry 102 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the token eviction circuitry 102 of FIG. 2 and/or representative of example operations which may be performed by programmable circuitry to implement and/or instantiate the token eviction circuitry 102 of FIG. 2, are shown in FIGS. 4 and 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 4 and 5, many other methods of implementing the example token eviction circuitry 102 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to implement the model execution circuitry 100 of FIG. 1. The example machine-readable instructions and/or the example operations 400 of FIG. 4 begin at block 402, at which the token eviction circuitry 102 (FIGS. 1 and 2) initializes the KV cache 104 (FIG. 1), the score history vector 205 (FIG. 2), and the score count vector 207 (FIG. 2). For example, the token grouping circuitry 204 splits the KV cache 104 into three parts based on a user defined start tokens length 211 (FIG. 2), evicting tokens length 213 (FIG. 2), and recent tokens length 215 (FIG. 2). The token importance circuitry 206 initializes the score history vector 205 to be equivalent to variable “current importance score” plus variable “attention scores”, where the variable “current importance score” is set to the sum of d attention scores 209 (FIG. 2) for a token and the variable “attention scores” is set to the attention scores 209 output by the model processing circuitry 106 (FIG. 1). The token importance circuitry 206 initializes the score count vector 207 to be equivalent to a variable “score count” plus one, where the variable “score count” is a number of iterations/cycles the model processing circuitry 106 has performed on the token.

In block 404, the token eviction circuitry 102 causes an execution of the model based on the KV cache 104 to create a new token. For example, the token eviction circuitry 102 notifies the model processing circuitry 106 that the KV cache 104 is ready for use in processing an input sequence.

In block 406, the token eviction circuitry 102 attempts to evict tokens from the KV cache 104 based on the KV cache 104, a new token, the score history vector, and the score count vector. For example, the model processing circuitry 106 stores new token 203 (FIG. 2) in the KV cache 104, which is propagated to the memory 202 (FIG. 2). The token eviction circuitry 102 assigns the new token 203 to a group of tokens (e.g., a block of memory, a page, etc.) in the KV cache 104, and then goes through a process of identifying intermediate ranked groups of tokens in the KV cache 104 with the lowest group importance scores that can be evicted. Block 406 is described in further detail below in connection with FIG. 5.

In block 408, the token eviction circuitry 102 determines whether execution of the model can be continued. For example, the token eviction circuitry 102 determines whether the model processing circuitry 106 has more tokens to output and, if so, continues to attempt to evict tokens from the KV cache 104 in order to keep the KV cache 104 size of a specified length during model execution.

In block 408, when the token eviction circuitry 102 determines that execution of the model is not to be continued (e.g., block 408 returns a value NO), the token eviction circuitry 102 provides an output (block 410). For example, the token eviction circuitry 102 may cause the model processing circuitry 106 to output the final token sequence to a user via a user interface or any other method.

The operations 400 of FIG. 4 end when the model execution circuitry 100 provides an output. The operations 400 may be repeated when a prompt is input to the model execution circuitry 100.

FIG. 5 is a flowchart representative of example machine readable instructions and/or example operations 406 that may be executed, instantiated, and/or performed by programmable circuitry to implement the token eviction circuitry 102 of FIGS. 1 and 2. The example machine-readable instructions and/or the example operations 406 of FIG. 5 begin at block 502, at which the token eviction circuitry 102 identifies the maximum token length. For example, the evicting circuitry 208 (FIG. 2) adds the start tokens length 211 to the evicting tokens length 213 and the recent tokens length 215.

At block 504, the token eviction circuitry 102 adds the new token to the KV cache 104. For example, the token grouping circuitry 204 (FIG. 2) prompts the model processing circuitry 106 to store the new token 203 (FIG. 2) in the recent tokens part of the KV cache 104.

At block 506, the token eviction circuitry 102 accesses the score history vectors 205 for each token. The score history vectors 205 for each token are generated as new tokens are added to the KV cache 104. For example, during initialization of the score history vector 205 in block 402 of FIG. 4, the token eviction circuitry 102 initializes the token importance circuitry 206 (FIG. 2) to generate a history score vector for each new token automatically (e.g., upon receipt of a new token). The token importance circuitry 206 adds n attention score matrices 209 corresponding to the token together to get current importance scores of the token and then adds the current importance scores of the token to the attention scores 209 of the token generate the score history vector 205.

At block 508, the token eviction circuitry accesses and increments the score count vector 207. For example, the token importance circuitry 206 adds one to the score count vector 207 in response to the new token added to the KV cache 104.

At block 510, the token eviction circuitry 102 updates the context data 201 (FIG. 2) based on the new token. For example, the evicting circuitry 208 concatenates the new token 203 to the context data 201 to update the context data 201.

At block 512, the token eviction circuitry 102 determines whether the length of the context data 201 exceeds the maximum token length. For example, the evicting circuitry 208 compares the updated context data 201 to the maximum token length to determine whether there are too many tokens stored in the KV cache 104.

At block 512, when length of the context data 201 is less than or equal to the maximum token length (e.g., block 512 returns a value NO), the token eviction circuitry 102 returns the score history vector 205 and the score count vector 207 in the memory 202 along with the updated context data 201 (block 514). For example, the evicting circuitry 208 stores the score history vector 205 and the score count vector 207 in the memory 202 along with the updated context data 201 and does not attempt to evict any groups of tokens from the KV cache 104.

At block 512, when the length of the context data 201 exceeds the maximum token length (e.g., block 512 returns a value YES), the token eviction circuitry 102 determines whether normalization should be performed (block 516). For example, the token importance circuitry 206 determines whether the score history vector 205 is to be normalized based on the normalization status 219.

At block 516, when the token importance circuitry 206 determines that the normalization status 219 indicates that the score history vector 205 is to be normalized (e.g., block 516 returns a value YES), the token eviction circuitry 102 normalizes the score history vector for each token based on the score count vector to obtain normalized importance scores (block 518). For example, the token importance circuitry 206 divides by the score count vector 207 by the score history vector 205 to obtain a normalized importance score.

At block 520, the token eviction circuitry 102 computes group importance scores for each group based on normalized importance scores of the tokens. For example, the token importance circuitry 206 sums the normalized importance scores of the tokens in the group to obtain the group score, and does that for each group in the KV cache 104.

At block 516, when the token importance circuitry 206 determines that the normalization status 219 indicates that the score history vector 205 is not to be normalized (e.g., block 516 returns a value NO), then the score history vectors 205 are defined to be the normalized importance score of the tokens and control turns to block 520.

At block 522, the token eviction circuitry 102 identifies top group importance scores for the maximum token length. For example, the evicting circuitry 208 determines a number of groups, having a total token count equal to the maximum token length (e.g., if the maximum token length is equal to 100 and the group size is equal to five, the number of groups is 20) and having the highest group importance scores.

At block 524, the token eviction circuitry 102 flags remaining groups in the KV cache 104 as intermediate. For example, the evicting circuitry 208 flags the remaining groups in the KV cache 104 that were not identified as a group having a high group score as an intermediate ranked group.

At block 526, the token eviction circuitry 102 evicts intermediate group(s) of tokens based on low group importance score(s) and on a location of the group(s) of tokens within the KV cache 104. For example, the evicting circuitry 208 identifies the intermediate ranked groups that are both located in the evicting part of the KV cache 104 and have the lowest group importance scores. Then the evicting circuitry 208 removes those lowest ranked groups from the KV cache 104. The evicting circuitry 208 maintains intermediate ranked groups of tokens in the KV cache 104 if the group of tokens are located earlier in the KV cache 104 than initial token threshold. For example, any additional intermediate ranked groups are kept in the start tokens part and/or the recent tokens part of the KV cache 104. In some examples, any additional intermediate ranked groups that do not have the lowest group importance scores are kept in the evicting tokens part of the KV cache 104.

Control returns to block 514, where the token eviction circuitry 102 returns the KV cache, the score history vector, and the score count vector and the operations 406 end. In some examples, the operations 406 may be repeated when a new token is generated and, thus, when a length of the context data has changed (e.g., increased).

FIG. 6 is a block diagram of an example programmable circuitry platform 600 structured to execute and/or instantiate the example machine-readable instructions and/or the example operations of FIGS. 4 and 5 to implement the token eviction circuitry 102 of FIG. 2. The programmable circuitry platform 600 can be, for example, a server, a personal computer, a workstation, a self-learning machine (e.g., a neural network), or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the model execution circuitry 100, the token eviction circuitry 102, the model processing circuitry 106, the token grouping circuitry 204, the token importance circuitry 206, and the evicting circuitry 208.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, and/or a touchscreen.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, and/or an in-place switching (IPS) display, a touchscreen, etc.). The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In this example, the mass storage devices 628 implement the example memory 108 and the example memory 202.

The machine readable instructions 632, which may be implemented by the machine readable instructions of FIGS. 4 and 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7.

Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and 5. As such, the FPGA circuitry 800 may be configured and/or structured to effectively instantiate some or all of the operations/functions corresponding to the machine readable instructions of the flowchart(s) of FIGS. 4 and 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4 and 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. [ER-Diagram] may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

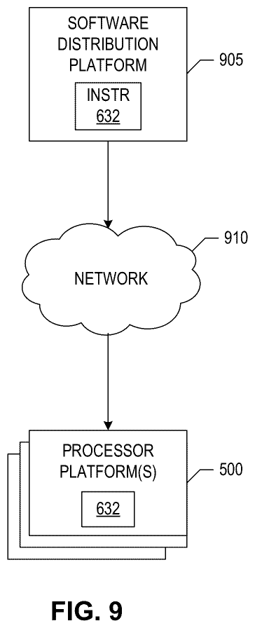

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and 5, may be downloaded to the example programmable circuitry platform 600, which is to execute the machine readable instructions 632 to implement the token eviction circuitry 102. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that efficient limit the size of memory required to store the KV cache of text generation models without compromising accuracy. Disclosed systems, apparatus, articles of manufacture, and methods improve the efficiency of using a computing device by improving cache memory size, allowing a model processing component to access cache memory faster. Disclosed systems, apparatus, articles of manufacture, and methods reduce memory requirements typically required to execute models, thus enabling execution of more models and/or handling for requests simultaneously. The reduction of memory requirements enables execution of models on resource constrained devices, such as mobile devices, tablets, consumer devices, etc. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to evict tokens from a key value cache are disclosed herein. Further examples and combinations thereof include the following:

Example 1 includes an apparatus to comprising interface circuitry, machine readable instructions, and programmable circuitry to at least one of instantiate or execute the machine readable instructions to determine score history values for tokens based on attention scores associated with the tokens, wherein a token is a numerical representation of text, after a number of tokens present in a key value cache exceeds a threshold number of tokens, compute group importance scores for groups of tokens based on respective score history values of the tokens in the groups of tokens, identify low-ranked groups of tokens having lowest group importance scores, the low-ranked groups of tokens associated with an eviction range in the key value cache, and remove an identified low-ranked group of tokens from the eviction range of the key value cache.

Example 2 includes the apparatus of example 1, wherein the programmable circuitry is to determine that score history values are to be normalized, access a score count value indicative of a number of iterations a machine learning model has executed on the tokens, and normalize the score history values based on the score count value.

Example 3 includes the apparatus of example 1, wherein the eviction range of the key value cache represents tokens present between an initial token threshold address and a recent token threshold address.

Example 4 includes the apparatus of example 1, wherein the programmable circuitry is to retain the low-ranked group of tokens within the key value cache if the low-ranked group of tokens is located in a plurality of earlier addresses in the key value cache than an initial token threshold address.

Example 5 includes the apparatus of example 1, wherein the programmable circuitry is to retain the low-ranked group of tokens if the low-ranked group of tokens is located in a plurality of later addresses in the key value cache than a recent token threshold address.

Example 6 includes the apparatus of example 1, wherein machine learning model is a text generation machine learning model that generates output text based on the tokens.

Example 7 includes the apparatus of example 1, wherein the programmable circuitry is to increment a score count value each time a machine learning model generates a new token.

Example 8 includes the apparatus of example 1, wherein the attention scores represent respective importances of the tokens for generation of subsequent tokens.

Example 9 includes the apparatus of example 1, wherein the threshold number of tokens is determined as a maximum number of tokens that will be allowed in the key value cache before tokens will be evicted from the key value cache.

Example 10 includes at least one non-transitory machine-readable medium comprising machine-readable instructions to cause at least one processor circuit to at least determine score history values for tokens based on attention scores associated with the tokens, wherein a token is a numerical representation of text, after a number of tokens present in a key value cache exceeds a threshold number of tokens, compute group importance scores for groups of tokens based on respective score history values of the tokens, identify low-ranked groups of tokens having lowest group importance scores, the low-ranked groups of tokens associated with an eviction range in the key value cache, and remove an identified low-ranked group of tokens from the eviction range of the key value cache.

Example 11 includes the at least one non-transitory machine-readable medium of example 10, wherein the machine-readable instructions are to cause one or more of the at least one processor circuit to determine that score history values are to be normalized, access a score count value indicative of a number of iterations the machine learning model has executed on the tokens, and normalize the score history values based on the score count value.

Example 12 includes the at least one non-transitory machine-readable medium of example 10, wherein eviction range of the key value cache represents tokens present between an initial token threshold address and a recent token threshold address.

Example 13 includes the at least one non-transitory machine-readable medium of example 10, wherein the key value cache is to retain the low-ranked group of tokens if the low-ranked group of tokens is located at a plurality of earlier addresses in the key value cache than an initial token threshold address.

Example 14 includes the at least one non-transitory machine-readable medium of example 10, wherein the key value cache is to retain the low-ranked group of tokens if the low-ranked group of tokens is located at a plurality of later addresses in the key value cache than a recent token threshold address.

Example 15 includes the at least one non-transitory machine-readable medium of example 10, wherein machine learning model is a text generation machine learning model that generates output text based on the tokens.

Example 16 includes the at least one non-transitory machine-readable medium of example 10, wherein the machine-readable instructions are to cause one or more of the at least one processor circuit is to increment a score count value each time the machine learning model generates a new token.

Example 17 includes the at least one non-transitory machine-readable medium of example 10, wherein the score history values are computed based on summing the attention scores, wherein the attention scores are generated by a machine learning model per token and represent respective importances of the tokens for generation of subsequent tokens.

Example 18 includes the at least one non-transitory machine-readable medium of example 10, wherein the threshold number of tokens is determined as a maximum number of tokens that will be allowed in the key value cache before tokens will be evicted from the key value cache.

Example 19 includes a method comprising determining score history values for tokens based on attention scores associated with the tokens, wherein a token is a numerical representation of text, after a number of tokens present in a key value cache exceeds a threshold number of tokens, computing group importance scores for groups of tokens based on respective score history values of the tokens in the groups of tokens, identifying low-ranked groups of tokens having lowest group importance scores, the low-ranked groups of tokens associated with an eviction range in the key value cache, and removing an identified low-ranked group of tokens from the eviction range of the key value cache.

Example 20 includes the method of example 19, further including determining that score history values are to be normalized, accessing a score count value indicative of a number of iterations a machine learning model has executed on the tokens, and normalizing the score history values based on the score count value.

Example 21 includes the method of example 19, wherein the eviction range of the key value cache represents tokens present between an initial token threshold address and a recent token threshold address.

Example 22 includes the method of example 19, further including retaining the low-ranked group of tokens within the key value cache if the low-ranked group of tokens is located at a plurality of earlier addresses in the key value cache than an initial token threshold address.

Example 23 includes the method of example 19, further including retaining the low-ranked group of tokens within the key value cache if the low-ranked group of tokens is located at a plurality of later addresses in the key value cache than a recent token threshold address.

Example 24 includes the method of example 19, wherein machine learning model is a text generation machine learning model that generates output text based on the tokens.

Example 25 includes the method of example 19, further including summing the attention scores to compute the score history values, wherein the attention scores are generated by a machine learning model per token and represent respective importances of the tokens for generation of subsequent tokens.

Example 26 includes the method of example 19, further including determining the threshold number of tokens as on a maximum number of tokens that will be allowed in the key value cache before tokens will be evicted from the key value cache.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to comprising:
interface circuitry;
machine readable instructions; and
programmable circuitry to at least one of instantiate or execute the machine readable instructions to:
determine score history values for tokens based on attention scores associated with the tokens, wherein a token is a numerical representation of text;
after a number of tokens present in a key value cache exceeds a threshold number of tokens, compute group importance scores for groups of tokens based on respective score history values of the tokens in the groups of tokens;
identify low-ranked groups of tokens having lowest group importance scores, the low-ranked groups of tokens associated with an eviction range in the key value cache; and
remove an identified low-ranked group of tokens from the eviction range of the key value cache.

2. The apparatus of claim 1, wherein the programmable circuitry is to:
determine that score history values are to be normalized;
access a score count value indicative of a number of iterations a machine learning model has executed on the tokens; and
normalize the score history values based on the score count value.

3. The apparatus of claim 1, wherein the eviction range of the key value cache represents tokens present between an initial token threshold address and a recent token threshold address.

4. The apparatus of claim 1, wherein the programmable circuitry is to retain the low-ranked group of tokens within the key value cache if the low-ranked group of tokens is located in a plurality of earlier addresses in the key value cache than an initial token threshold address.

5. The apparatus of claim 1, wherein the programmable circuitry is to retain the low-ranked group of tokens if the low-ranked group of tokens is located in a plurality of later addresses in the key value cache than a recent token threshold address.

6. The apparatus of claim 1, wherein machine learning model is a text generation machine learning model that generates output text based on the tokens.

7. The apparatus of claim 1, wherein the programmable circuitry is to increment a score count value each time a machine learning model generates a new token.

8. The apparatus of claim 1, wherein the attention scores represent respective importances of the tokens for generation of subsequent tokens.

9. The apparatus of claim 1, wherein the threshold number of tokens is determined as a maximum number of tokens that will be allowed in the key value cache before tokens will be evicted from the key value cache.

10. At least one non-transitory machine-readable medium comprising machine-readable instructions to cause at least one processor circuit to at least:
determine score history values for tokens based on attention scores associated with the tokens, wherein a token is a numerical representation of text;
after a number of tokens present in a key value cache exceeds a threshold number of tokens, compute group importance scores for groups of tokens based on respective score history values of the tokens;
identify low-ranked groups of tokens having lowest group importance scores, the low-ranked groups of tokens associated with an eviction range in the key value cache; and
remove an identified low-ranked group of tokens from the eviction range of the key value cache.

11. The at least one non-transitory machine-readable medium of claim 10, wherein the machine-readable instructions are to cause one or more of the at least one processor circuit to:
determine that score history values are to be normalized;
access a score count value indicative of a number of iterations the machine learning model has executed on the tokens; and
normalize the score history values based on the score count value.

12. The at least one non-transitory machine-readable medium of claim 10, wherein the eviction range of the key value cache represents tokens present between an initial token threshold address and a recent token threshold address.

13. The at least one non-transitory machine-readable medium of claim 10, wherein the key value cache is to retain the low-ranked group of tokens if the low-ranked group of tokens is located at a plurality of earlier addresses in the key value cache than an initial token threshold address.

14. The at least one non-transitory machine-readable medium of claim 10, wherein the key value cache is to retain the low-ranked group of tokens if the low-ranked group of tokens is located at a plurality of later addresses in the key value cache than a recent token threshold address.

15. The at least one non-transitory machine-readable medium of claim 10, wherein machine learning model is a text generation machine learning model that generates output text based on the tokens.

16. The at least one non-transitory machine-readable medium of claim 10, wherein the machine-readable instructions are to cause one or more of the at least one processor circuit is to increment a score count value each time the machine learning model generates a new token.

17. The at least one non-transitory machine-readable medium of claim 10, wherein the score history values are computed based on summing the attention scores, wherein the attention scores are generated by a machine learning model per token and represent respective importances of the tokens for generation of subsequent tokens.

18. The at least one non-transitory machine-readable medium of claim 10, wherein the threshold number of tokens is determined as a maximum number of tokens that will be allowed in the key value cache before tokens will be evicted from the key value cache.

19. A method comprising:
determining score history values for tokens based on attention scores associated with the tokens, wherein a token is a numerical representation of text;
after a number of tokens present in a key value cache exceeds a threshold number of tokens, computing group importance scores for groups of tokens based on respective score history values of the tokens in the groups of tokens;
identifying low-ranked groups of tokens having lowest group importance scores, the low-ranked groups of tokens associated with an eviction range in the key value cache; and
removing an identified low-ranked group of tokens from the eviction range of the key value cache.

20. The method of claim 19, further including:
determining that score history values are to be normalized;
accessing a score count value indicative of a number of iterations a machine learning model has executed on the tokens; and
normalizing the score history values based on the score count value.
